(19) United States
(12) Patent Application Publication
(10) Pub. No.: US 2005/0087058 A1
(43) Pub. Date: Apr. 28, 2005

(54) Musical instrument stand having angle adjustable function

(76) Inventor: Jung-Pin Chang, Taichung (TW)

Correspondence Address: Alan D. Kamrath;Nikolai & Mersereau P.A., Suite 820 International Centre, 900 Second Avenue, South Minneapolis, MN, 55402, US

(21) Appl. No.: 10/694,580

(22) Filed: Oct. 23, 2003

(51) Int. Cl. G10D 13/02

(52) U.S. Cl. 84/422.1

(57) ABSTRACT

A musical instrument stand includes an angle adjusting device including a first connecting block having an upper end formed with a circular shell having a periphery formed with an annular toothed portion, a second connecting block having a lower end formed with a circular shell pivotally mounted on the circular shell of the first connecting block and having a plurality of toothed portions, and a circular soft pad mounted between the annular toothed portion of the first connecting block and the toothed portions of the second connecting block. Thus, the inclined angle of the cymbal can be adjusted slightly in an exact manner, thereby facilitating the user adjusting the inclined angle of the cymbal.

### BACKGROUND OF THE INVENTION

1. Field of the Invention

The present invention relates to a musical instrument stand, and more particularly to a musical instrument stand having an angle adjustable function.

2. Description of the Related Art

A conventional musical instrument stand in accordance with the prior art shown in FIGS. 1-4 comprises a base 1, a shaft 2 having a lower end mounted on the base 1, an angle adjusting device 3 mounted on an upper end of the shaft 2, a support rod 40 mounted on the angle adjusting device 3, a mounting seat 50 mounted on the support rod 40, and a cymbal 9 mounted on the mounting seat 50.

The angle adjusting device 3 includes a first connecting block 10 having a lower end formed with a mounting portion 12 mounted on the upper end of the shaft 2 and an upper end formed with a circular shell 11, and a second connecting block 20 having a lower end formed with a circular shell 21 pivotally mounted on the circular shell 11 of the first connecting block 10 and an upper end formed with a tube 22 formed with a screw bore 23. The circular shell 11 of the first connecting block 10 has an inside formed with a recess 13 having a through hole 14 and has a periphery 15 formed with a convex toothed portion 16 protruded from the periphery 15. The circular shell 21 of the second connecting block 20 has an inside formed with a stub 24 mounted in the through hole 14 of the first connecting block 10 and formed with a screw bore 25. The circular shell 21 of the second connecting block 20 has a periphery 26 formed with a concave toothed portion 27 protruded from the periphery 26 and engaged with the convex toothed portion 16 of the first connecting block 10. The angle adjusting device 3 further includes a wing bolt 32 in turn extended through a washer 31, the through hole 14 of the first connecting block 10, a conical spring 30 and screwed into the screw bore 25 of the stub 24 of the second connecting block 20, so that the first connecting block 10 is combined with the second connecting block 20. The conical spring 30 has a first end received in the recess 13 of the first connecting block 10 and a second end mounted on the stub 24 of the second connecting block 20.

The support rod 40 has a lower end formed with an outer thread 43 extended through a nut 4 and screwed into the screw bore 23 of the tube 22 of the second connecting block 20, and an upper end formed with an outer thread 42. The support rod 40 has a mediate portion formed with a grip portion 41 having an upper end formed with an upper abutting edge 44 and a lower end formed with a lower abutting edge 45 rested on the tube 22 of the second connecting block 20. The mounting seat 50 has a base portion 51 rested on the upper abutting edge 44 of the support rod 40, and a mounting portion 52 formed on the base portion 51.

The conventional musical instrument stand further comprises a lower gasket 5 mounted on the mounting portion 52 of the mounting seat 50 and rested on a bottom of the cymbal 9, an upper gasket 7 mounted on the upper end of the support rod 40 and rested on a top of the cymbal 9, and a wing nut 8 screwed on the outer thread 42 of the upper end of the support rod 40 and urged on the upper gasket 7, so that the cymbal 9 is clamped between the upper gasket 7 and the lower gasket 5.

In operation, when the wing bolt 32 is unscrewed from the screw bore 25 of the stub 24 of the second connecting block 20, the first connecting block 10 is separated from the second connecting block 20 by the elastic force of the conical spring 30, thereby disengaging the concave toothed portion 27 of the second connecting block 20 from the convex toothed portion 16 of the first connecting block 10, so that the second connecting block 20 can be rotated relative to the first connecting block 10 so as to change the inclined angle of the second connecting block 20, thereby adjusting the inclined angle of the cymbal 9 as shown in FIG. 4. Then, the wing bolt 32 is again screwed into the screw bore 25 of the stub 24 of the second connecting block 20, so that the first connecting block 10 is combined with the second connecting block 20.

Thus, the inclined angle of the second connecting block 20 is adjusted by changing the relative position between the concave toothed portion 27 of the second connecting block 20 and the convex toothed portion 16 of the first connecting block 10 so as to adjust the inclined angle of the cymbal 9 in an approximate manner.

However, the inclined angle of the second connecting block 20 cannot be adjusted exactly and slightly due to the tooth thickness of the concave toothed portion 27 of the second connecting block 20 and the convex toothed portion 16 of the first connecting block 10, so that the inclined angle of the cymbal 9 cannot be adjusted slightly in an exact manner, thereby causing inconvenience to the user. In addition, the inclined angle of the second connecting block 20 is easily deflected slightly due to the tooth clearance of the concave toothed portion 27 of the second connecting block 20 and the convex toothed portion 16 of the first connecting block 10, thereby affecting the inclined angle of the cymbal 9.

### SUMMARY OF THE INVENTION

The primary objective of the present invention is to provide a musical instrument stand having an angle adjustable function.

Another objective of the present invention is to provide a musical instrument stand, wherein the second connecting block is rotated relative to the first connecting block to arbitrarily change the relative position and angle between the second connecting block and the first connecting block without any limitation so as to adjust the inclined angle of the cymbal exactly and slightly, so that the inclined angle of the cymbal can be adjusted slightly in an exact manner, thereby facilitating the user adjusting the inclined angle of the cymbal.

A further objective of the present invention is to provide a musical instrument stand, wherein the soft pad is clamped between the annular toothed portion of the first connecting block and the convex toothed portions of the second connecting block, so that the first connecting block is combined with the second connecting block rigidly and stably. Thus, the inclined angle of the second connecting block is fixed and will not be deflected slightly after adjustment, thereby maintaining the inclined angle of the cymbal.

In accordance with the present invention, there is provided a musical instrument stand, comprising an angle adjusting device including:
a first connecting block having an upper end formed with a circular shell having a periphery formed with an annular toothed portion;
a second connecting block having a lower end formed with a circular shell pivotally mounted on the circular shell of the first connecting block and having a plurality of toothed portions; and
a circular soft pad mounted between the annular toothed portion of the first connecting block and the toothed portions of the second connecting block.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional musical instrument stand in accordance with the prior art;

FIG. 2 is a perspective assembly view of the conventional musical instrument stand as shown in FIG. 1;

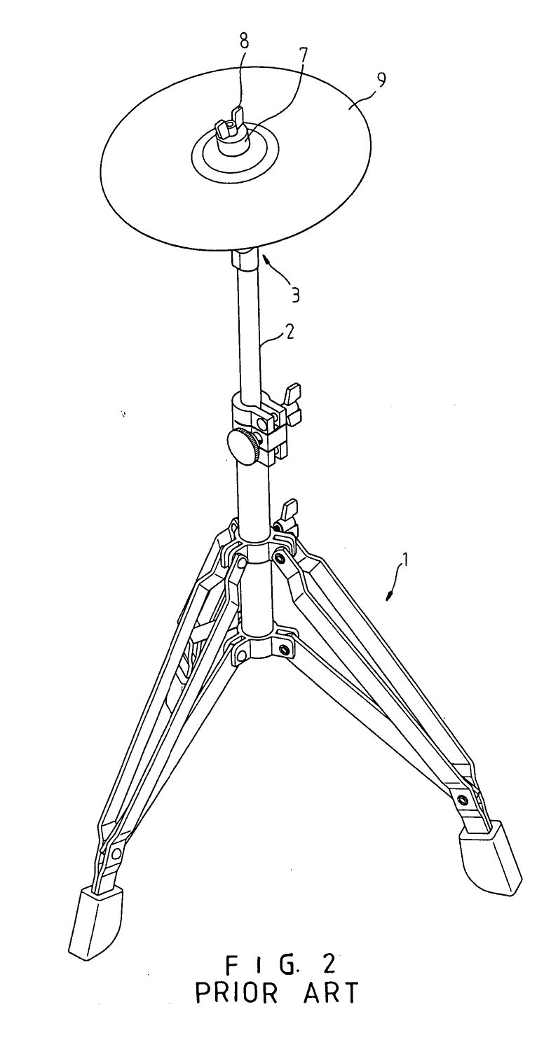

FIG. 3 is a partially cut-away plan cross-sectional assembly view of the conventional musical instrument stand as shown in FIG. 1;

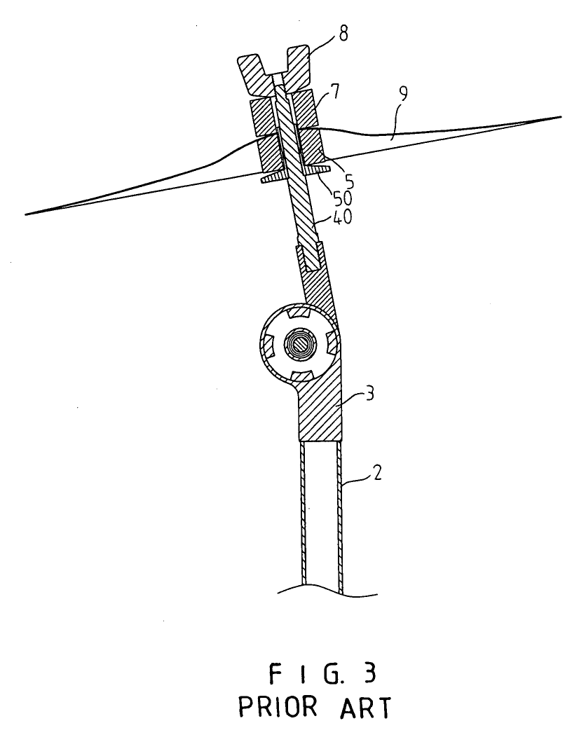

FIG. 4 is a schematic plan operational view of the conventional musical instrument stand as shown in FIG. 3;

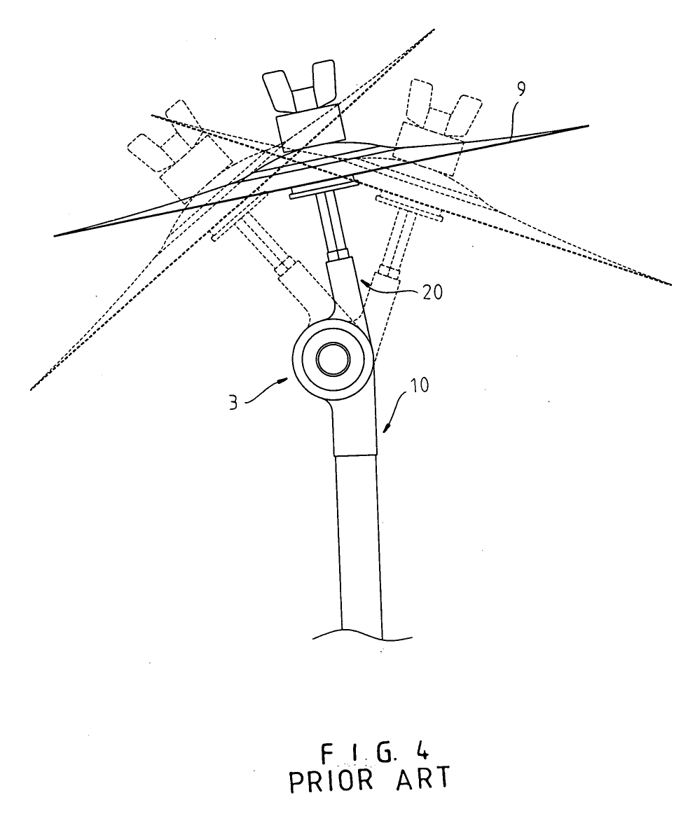

FIG. 5 is an exploded perspective view of a musical instrument stand in accordance with the preferred embodiment of the present invention;

FIG. 6 is a partially cut-away plan cross-sectional assembly view of the musical instrument stand as shown in FIG. 5;

FIG. 7 is an exploded perspective view of a musical instrument stand in accordance with another embodiment of the present invention; and

FIG. 8 is an exploded perspective view of a musical instrument stand in accordance with another embodiment of the present invention.

### DETAILED DESCRIPTION OF THE INVENTION

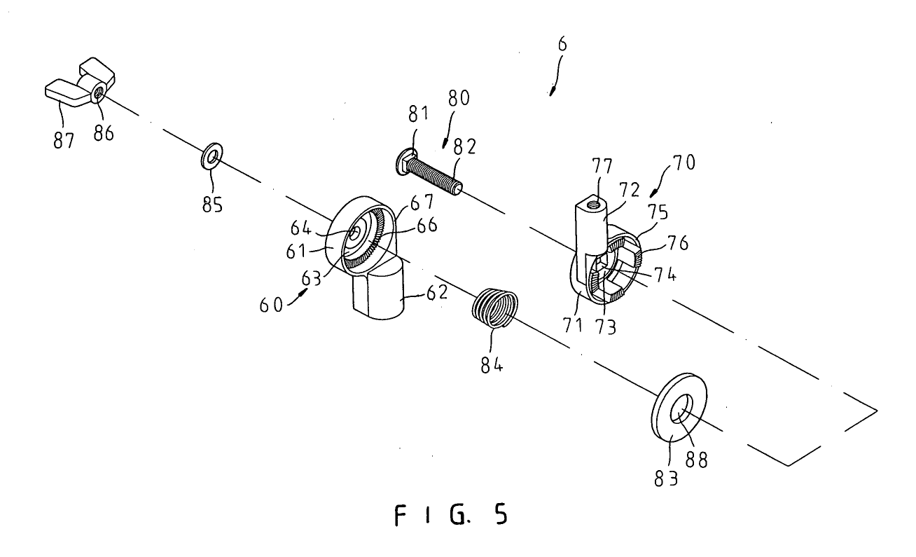

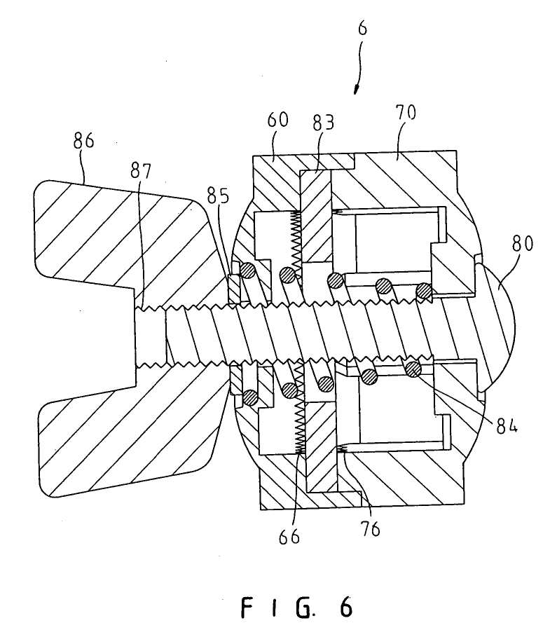

Referring to the drawings and initially to FIGS. 5 and 6, a musical instrument stand in accordance with the preferred embodiment of the present invention comprises an angle adjusting device 6 mounted on an upper end of the shaft 2.

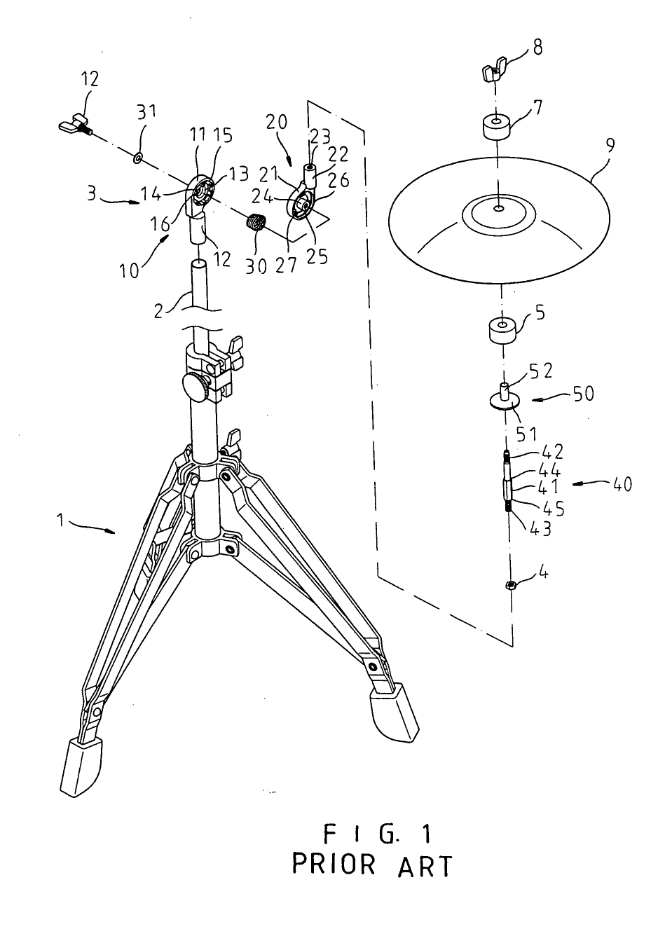

The angle adjusting device 6 includes a first connecting block 60 having a lower end formed with a mounting portion 62 mounted on the upper end of the shaft 2 (see FIG. 1) and an upper end formed with a circular shell 61, and a second connecting block 70 having a lower end formed with a circular shell 71 pivotally mounted on the circular shell 61 of the first connecting block 60 and an upper end formed with a tube 72 formed with a screw bore 77 for screwing the outer thread 43 (see FIG. 1) of the support rod 40 (see FIG. 1).

The circular shell 61 of the first connecting block 60 has a recessed inside having a center formed with a circular lug 63 having a center formed with a through hole 64 and has a periphery 67 formed with an annular toothed portion 66 located in the periphery 67. The circular shell 61 of the first connecting block 60 is formed with an annular groove 65 located between the annular toothed portion 66 and the circular lug 63.

The circular shell 71 of the second connecting block 70 has a recessed inside having a center formed with a circular lug 73 having a center formed with a rectangular hole 74 and has a periphery 75 formed with a plurality of convex toothed portions 76 each protruded outward from the periphery 75.

The angle adjusting device 6 further includes a circular soft pad 83 mounted between the annular toothed portion 66 of the first connecting block 60 and the convex toothed portions 76 of the second connecting block 70, a bolt 82 in turn extended through the rectangular hole 74 of the second connecting block 70, the soft pad 83, a conical spring 84, the through hole 64 of the first connecting block 60 and a washer 85, and a wing nut 86 screwed on a distal end of the bolt 80 and rested on the washer 85, so that the first connecting block 60 is combined with the second connecting block 70.

The soft pad 83 has a center formed with a through hole 88 for passage of the bolt 80. The through hole 88 of the soft pad 83 has a size greater than that of the conical spring 84. The conical spring 84 has a first end rested on the circular lug 63 of the first connecting block 60 and a second end rested on the circular lug 73 of the second connecting block 70. The wing nut 86 is formed with an inner thread 87 screwed on a threaded rod 82 of the bolt 80. The bolt 80 has an end formed with a rectangular portion 81 mounted in the rectangular hole 74 of the second connecting block 70, thereby facilitating assembly of the first connecting block 60 and the second connecting block 70.

In assembly, the soft pad 83 is clamped between the annular toothed portion 66 of the first connecting block 60 and the convex toothed portions 76 of the second connecting block 70, so that the first connecting block 60 is combined with the second connecting block 70 rigidly and stably.

In operation, when the wing nut 86 is unscrewed from the threaded rod 82 of the bolt 80, the first connecting block 60 is separated from the second connecting block 70 by the elastic force of the conical spring 84, thereby detaching the soft pad 83 from the annular toothed portion 66 of the first connecting block 60 and the convex toothed portions 76 of the second connecting block 70, so that the second connecting block 70 can be rotated relative to the first connecting block 60 so as to change the inclined angle of the second connecting block 70, thereby adjusting the inclined angle of the cymbal 9 (see FIG. 1). Then, the wing nut 86 is again screwed on the threaded rod 82 of the bolt 80, to clamp the soft pad 83 between the annular toothed portion 66 of the first connecting block 60 and the convex toothed portions 76 of the second connecting block 70, so that the first connecting block 60 is combined with the second connecting block 70 rigidly and stably.

Thus, the inclined angle of the second connecting block 70 is adjusted by changing the relative position and angle between the second connecting block 70 and the first connecting block 60 so as to adjust the inclined angle of the cymbal 9 exactly.

Accordingly, the second connecting block 70 is rotated relative to the first connecting block 60 to arbitrarily change the relative position and angle between the second connecting block 70 and the first connecting block 60 without any limitation so as to adjust the inclined angle of the cymbal 9 exactly and slightly, so that the inclined angle of the cymbal 9 can be adjusted slightly in an exact manner, thereby facilitating the user adjusting the inclined angle of the cymbal 9. In addition, the soft pad 83 is clamped between the annular toothed portion 66 of the first connecting block 60 and the convex toothed portions 76 of the second connecting block 70, so that the first connecting block 60 is combined with the second connecting block 70 rigidly and stably. Thus, the inclined angle of the second connecting block 70 is fixed and will not be deflected slightly after adjustment, thereby maintaining the inclined angle of the cymbal 9.

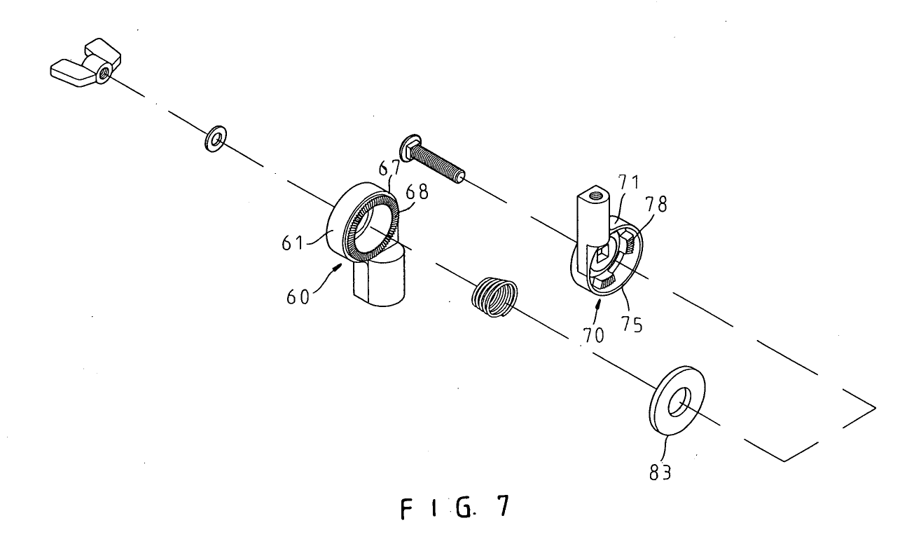

Referring to FIG. 7, a musical instrument stand in accordance with another embodiment of the present invention is shown, wherein the circular shell 61 of the first connecting block 60 has a periphery 67 formed with an annular toothed portion 68 protruding outward from the periphery 67, the circular shell 71 of the second connecting block 70 has a periphery 75 formed with a plurality of concave toothed portions 78 each located in the periphery 75, and the circular soft pad 83 is clamped between the annular toothed portion 68 of the first connecting block 60 and the concave toothed portions 78 of the second connecting block 70.

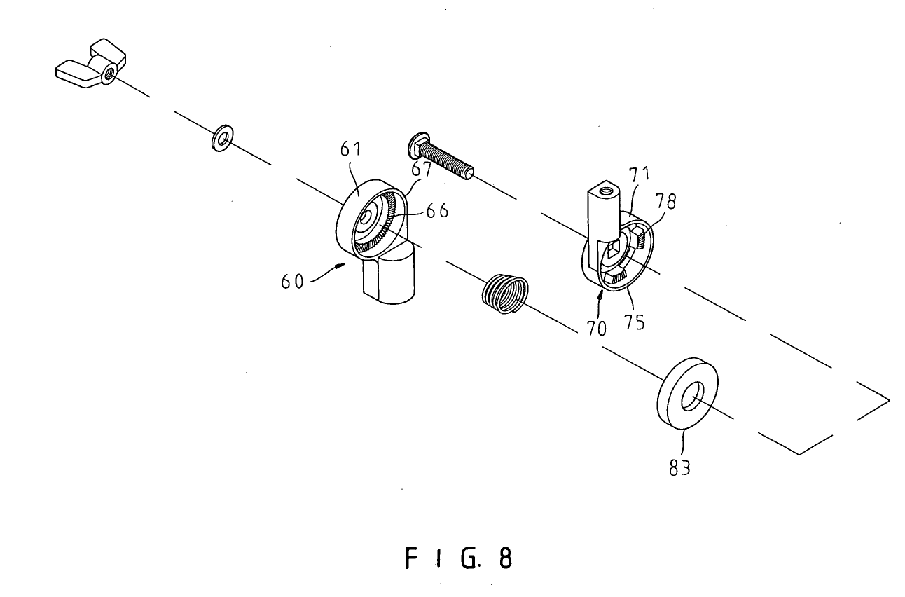

Referring to FIG. 8, a musical instrument stand in accordance with another embodiment of the present invention is shown, wherein the circular shell 61 of the first connecting block 60 has a periphery 67 formed with an annular toothed portion 66 located in the periphery 67, the circular shell 71 of the second connecting block 70 has a periphery 75 formed with a plurality of concave toothed portions 78 each located in the periphery 75, and the circular soft pad 83 is clamped between the annular toothed portion 66 of the first connecting block 60 and the concave toothed portions 78 of the second connecting block 70.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A musical instrument stand, comprising an angle adjusting device including:
a first connecting block having an upper end formed with a circular shell having a periphery formed with an annular toothed portion;
a second connecting block having a lower end formed with a circular shell pivotally mounted on the circular shell of the first connecting block and having a plurality of toothed portions; and
a circular soft pad mounted between the annular toothed portion of the first connecting block and the toothed portions of the second connecting block.

2. The musical instrument stand in accordance with claim 1, wherein the circular shell of the first connecting block has a recessed inside having a center formed with a circular lug having a center formed with a through hole, the circular shell of the second connecting block has a recessed inside having a center formed with a circular lug having a center formed with a rectangular hole, and the angle adjusting device further includes a bolt in turn extended through the rectangular hole of the second connecting block, the soft pad, a conical spring, the through hole of the first connecting block and a washer, and a wing nut screwed on a distal end of the bolt and rested on the washer, so that the first connecting block is combined with the second connecting block.

3. The musical instrument stand in accordance with claim 2, wherein the circular shell of the first connecting block is formed with an annular groove located between the annular toothed portion and the circular lug.

4. The musical instrument stand in accordance with claim 2, wherein the soft pad has a center formed with a through hole for passage of the bolt.

5. The musical instrument stand in accordance with claim 4, wherein the through hole of the soft pad has a size greater than that of the conical spring.

6. The musical instrument stand in accordance with claim 2, wherein the conical spring has a first end rested on the circular lug of the first connecting block and a second end rested on the circular lug of the second connecting block.

7. The musical instrument stand in accordance with claim 2, wherein the wing nut is formed with an inner thread screwed on a threaded rod of the bolt.

8. The musical instrument stand in accordance with claim 2, wherein the bolt has an end formed with a rectangular portion mounted in the rectangular hole of the second connecting block.

9. The musical instrument stand in accordance with claim 1, wherein the annular toothed portion of the first connecting block is located in the periphery of the first connecting block.

10. The musical instrument stand in accordance with claim 1, wherein the annular toothed portion of the first connecting block is protruded outward from the periphery of the first connecting block.

11. The musical instrument stand in accordance with claim 1, wherein each of the toothed portions of the second connecting block is protruded outward from the periphery of the second connecting block.

12. The musical instrument stand in accordance with claim 1, wherein each of the toothed portions of the second connecting block is located in the periphery of the second connecting block.
